(19) United States
(12) Patent Application Publication
(10) Pub. No.: US 2016/0065809 A1
(43) Pub. Date: Mar. 3, 2016

(54) DIGITAL CAMERA

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: DAI-PENG ZHU, Shenzhen (CN); SHU-SHENG PENG, Shenzhen (CN); JUN-HUI YU, Shenzhen (CN); YONG LI, Shenzhen (CN); SHIN-WEN CHEN, New Taipei (TW); CHIEN-LIANG CHOU, New Taipei (TW)

(21) Appl. No.: 14/575,346

(22) Filed: Dec. 18, 2014

(30) Foreign Application Priority Data
Sep. 1, 2014 (CN) 201410439534.4

(51) Int. Cl. H04N 5/225; G02B 7/00; G02B 5/20; G06K 9/00; H04N 5/238

(52) U.S. Cl. CPC H04N 5/2254; G06K 9/00604; H04N 5/238; G02B 5/208; G02B 7/005

(57) ABSTRACT

A digital camera able to filter out infrared light or receive infrared light as user requires includes a sensor and a base. The base includes a first receiving groove, the first receiving groove includes a bottom surface defining a first through slot, the first through slot being used for receiving the sensor. A filter bracket is set on the bottom surface, the filter bracket includes a first through hole and a second through hole corresponding to the first through slot. A visible light filter is set on the filter bracket and covers the first through hole and an infrared light filter covers the second through hole. A driver device moves the filter bracket from a first position to a second position as the user requires.

### FIELD

The subject matter herein generally relates to image capturing devices.

### BACKGROUND

A digital camera is used to capture an image of an object on an image sensor by receiving the visible light from the object. The digital camera has an infrared light filter or an UV light filter to avoid UV light or infrared light influencing image quality. However, the digital camera with an iris recognition function is more and more important for the applications of digital camera and the recognition function must be applied to an image of an object which includes infrared light.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figures.

FIG. 1 is an isometric view of a digital camera, according to one embodiment.

FIG. 2 is an exploded isometric view of the digital camera in FIG. 1.

FIG. 3 is another exploded, isometric view of the digital camera in FIG. 1.

FIG. 4 is an isometric view of the digital camera of FIG. 1 in use.

FIG. 5 is another isometric view of the digital camera of FIG. 1 in use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure is described in relation to a digital camera for iris recognition.

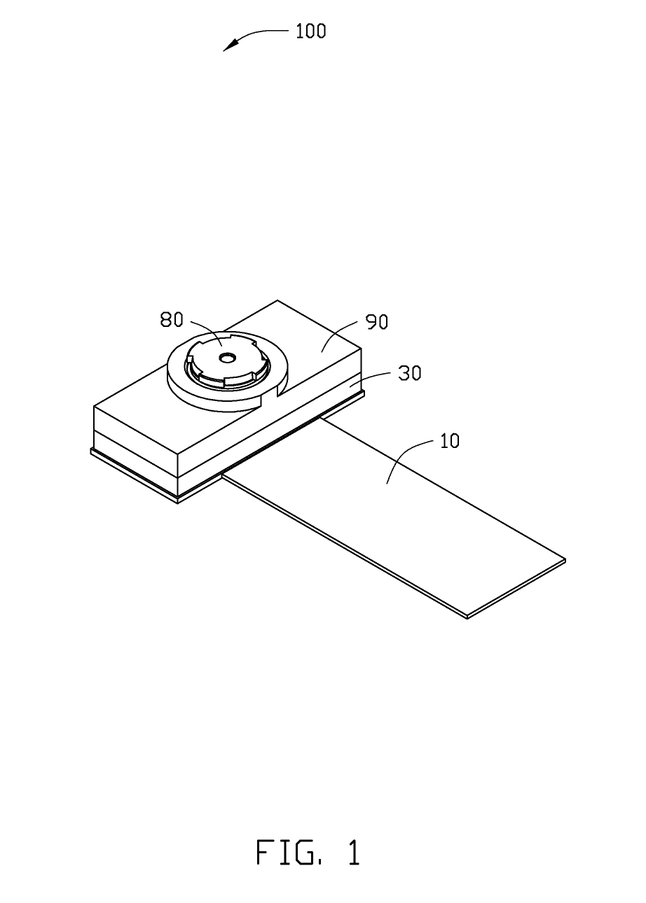

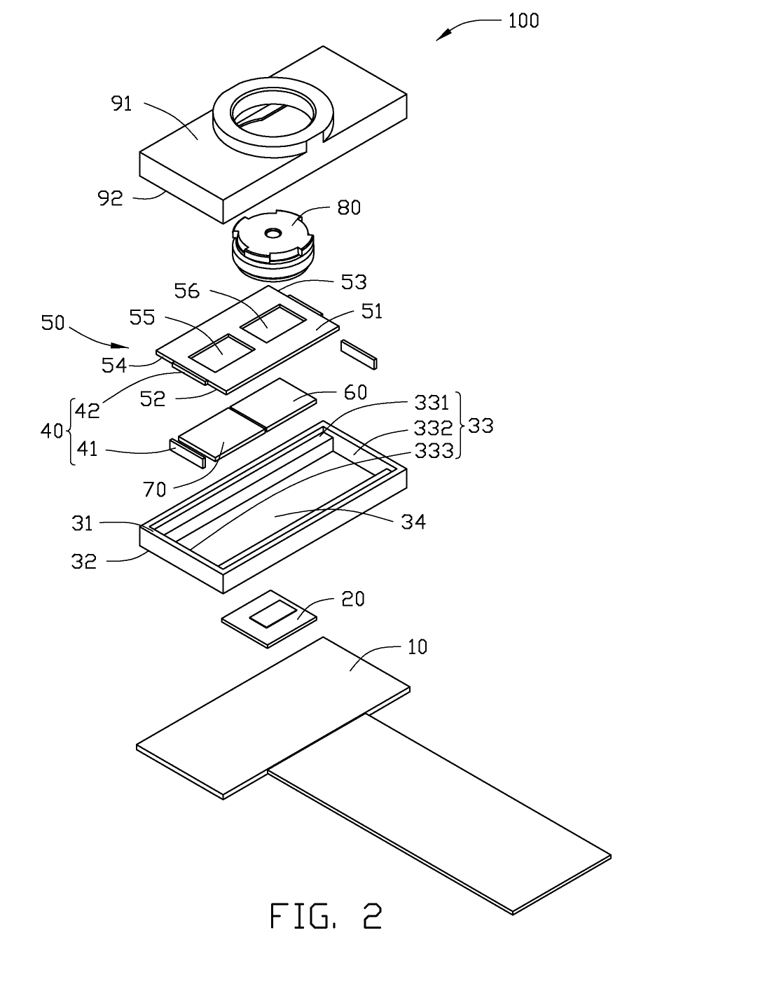

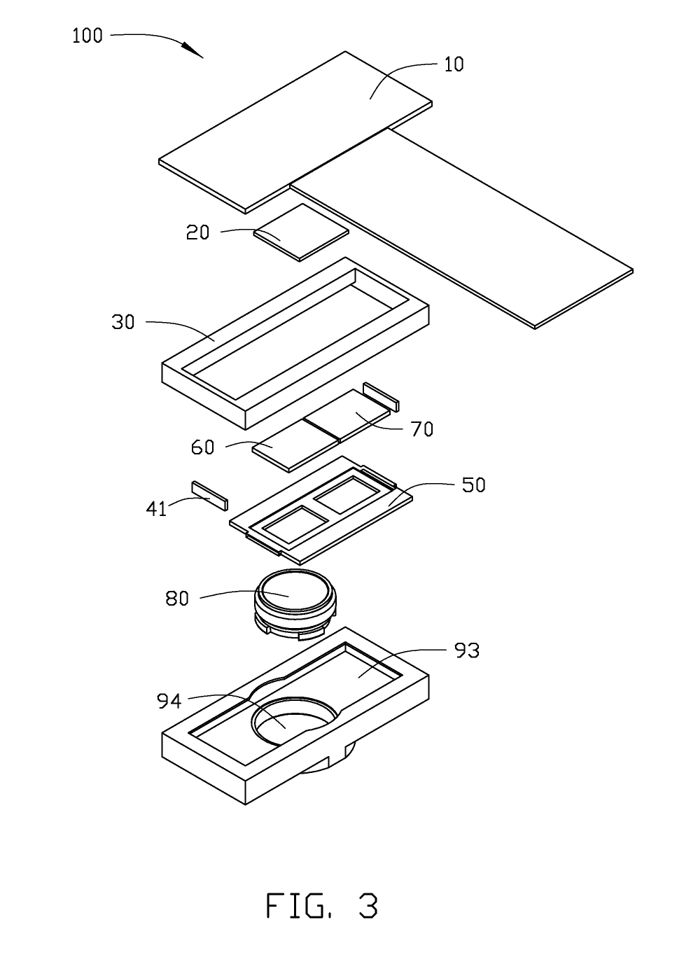

An embodiment of a digital camera 100 is shown in FIGS. 1, 2 and 3. The digital camera 100 includes a circuit board 10, a sensor 20, a base 30, a driver device 40, a filter bracket 50, a visible light filter 60, an infrared light filter 70, a lens 80, and a lens holder 90.

The base 30 includes a first surface 31, a second surface 32 opposite to the first surface 31, and a first receiving groove 33. The first receiving groove 33 includes a bottom surface 331, a first side wall 332 vertically connected to the bottom surface, and a second side wall 333 opposite to the first side wall, The bottom surface 331 defines a first through slot 34 configured to receive the sensor 20.

The driver device 40 includes two electromagnets 41 and two permanent magnets 42. The magnetic poles of the electromagnets 41 is changed by changing a direction of current through a coil of the electromagnets 41.

The filter bracket 50 includes a third surface 51, a fourth surface 52 opposite to the third surface 51, a third side wall 53 interconnected between the third surface 51 and the fourth surface 52, a fourth side wall 54 opposite to the third side wall 53, a first through hole 55, and a second through hole 56. The first through hole 55 and the second through hole 56 are positioned along a same first direction.

The lens holder 90 includes a fifth surface 91, a sixth surface 92 opposite to the fifth surface 91, and a second receiving groove 93. A hole 94 is connected to the second receiving groove 93 and through out the fifth surface 91, the lens 80 is positioned in the hole 94.

The sensor 20 is positioned on the circuit board 10 and faces the lens 80. The base 30 is positioned between the circuit board 10 and the lens holder 90, the first through slot 34 of the bottom surface 331 of the base 30 receives the sensor 20. One electromagnet 41 is positioned at the first side wall 332, the other electromagnet 41 is positioned at the second side wall 333. The electromagnets 41 are opposite to each other along the first direction, the magnetic poles of the electromagnets 41 having the same direction and being parallel to the first direction. One of the permanent magnets 42 is positioned to the third side wall 53, the other permanent magnet 42 is positioned on the fourth side wall 54, the permanent magnets 42 are opposite each other. The field strengths of the permanent magnets 42 are equal and the magnetic poles of the permanent magnets 42 oppose each other along the first direction. Each one of the permanent magnets 42 corresponds to an electromagnet 41. The filter bracket 50 is positioned at the bottom surface 331, the first through hole 55 and the second through hole 56 correspond to the first through slot 34. The visible light filter 60 and the infrared light filter 70 are positioned on the filter bracket 50. The visible light filter 60 covers the first through hole 55 and the infrared light filter 70 covers the second through hole 56. The lens 80 is positioned in the hole 94 of the lens holder 90, and the lens holder 90 is fixed to the first surface 31 of the base 30.

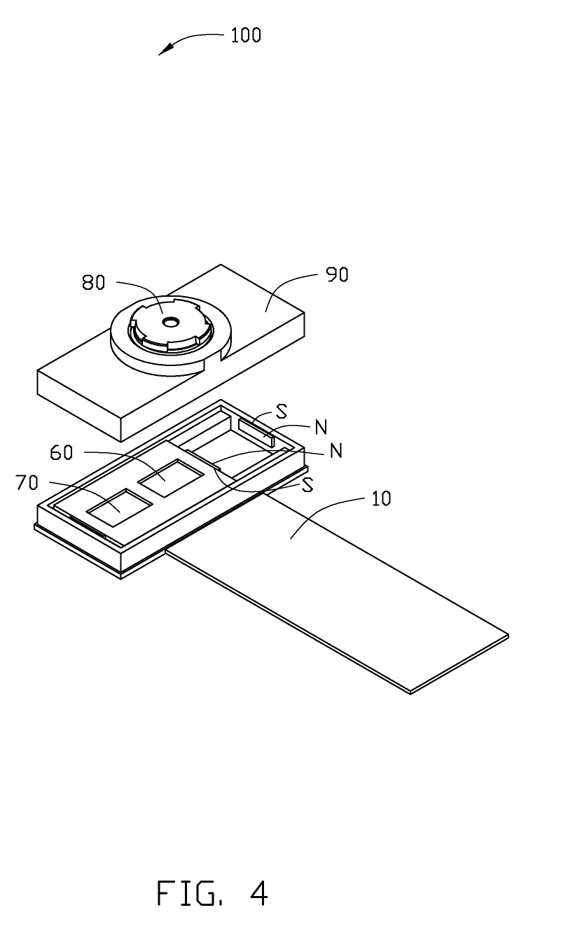

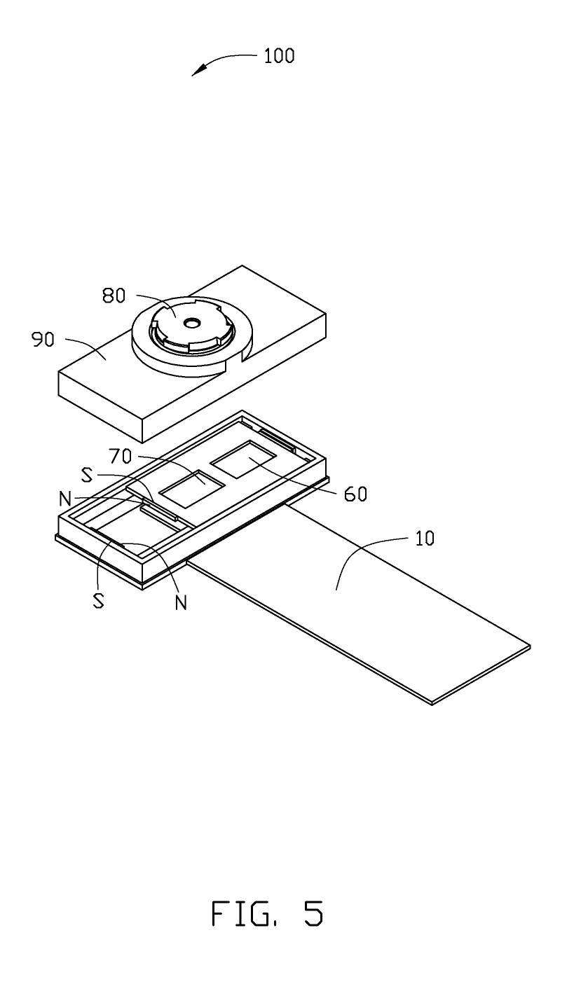

The application modes of the digital camera 100 are shown in FIGS. 4 and 5. When a user captures a high-quality image with the digital camera 100, the driver device 40 to move the filter bracket 50 to a first position. In the first position, the visible light filter 60 is positioned between the lens 80 and the sensor 20, the visible light (of wavelength 400-700 nm) is transmitted through the visible light filter 60 to be received by the sensor 20. When recognition of an iris of the eye by the digital camera 100 is executed, the magnetic poles of the electromagnets 41 is changed by changing direction of current of a coil of the electromagnets 41. The permanent magnets 42 and the electromagnets 41 magnetically interact, being configured to move the filter bracket 50 from the first position to a second position along the first direction, in the second position, the infrared light filter 70 is positioned between the lens 80 and the sensor 20 and infrared light (of wavelength 800-850 nm) is included in the transmission of light through the infrared filter 70 to be received by the sensor 20.

The embodiments shown and described above are only examples. Many details are often found in the art such as the other features of a digital camera. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A digital camera, comprising:
a lens;
a sensor facing the lens;
a base including a first receiving groove, the first receiving groove comprising a bottom surface defining a first through slot configured to receive the sensor;
a filter bracket including a first through hole and a second through hole corresponding to the first through slot, the filter bracket is positioned at the bottom surface;
a visible light filter covering the first through hole;
an infrared light filter covering the second through hole; and
a driver device configured to move the filter bracket from a first position to a second position;
wherein, in the first position the visible light filter is positioned between the lens and the sensor and in the second position the infrared filter is positioned between the lens and the sensor.

2. The digital camera in accordance with claim 1, wherein the driver device includes two electromagnets and two permanent magnets.

3. The digital camera in accordance with claim 1, wherein the first receiving groove includes a first side wall vertically connected to the bottom surface and a second side wall opposite to the first side wall.

4. The digital camera in accordance with claim 3, wherein the driver device includes two electromagnets and two permanent magnets, one of the electromagnets is positioned to the first side wall, the other electromagnet is positioned to the second side wall, the electromagnets are opposite to each other along a first direction, the field strengths of the electromagnets are equal and the magnetic poles of the electromagnets are parallel to the first direction.

5. The digital camera in accordance with claim 4, wherein two of the permanent magnets are positioned at the filter bracket, the permanent magnets are opposite each other, the field strengths of the permanent magnets are equal and the magnetic poles of the permanent magnets oppose each other along the first direction, the permanent magnets and the electromagnets magnetically interact, being configured to move the filter bracket along the first direction.

6. The digital camera in accordance with claim 1, wherein the filter bracket includes a third side wall and a fourth side wall opposite to the third side wall.

7. The digital camera in accordance with claim 6, wherein one of the permanent magnets is positioned to the third side wall and the other permanent magnet is positioned to the fourth side wall.

8. The digital camera in accordance with claim 4, wherein the first through hole and the second through hole are positioned along the first direction.

9. A digital camera, comprising:
a lens;
a sensor facing the lens;
a base including a first receiving groove, the first receiving groove comprising a bottom surface defining a first through slot configured to receive the sensor;
a filter bracket including a first through hole and a second through hole, the filter bracket is positioned at the bottom surface;
a visible light filter covering the first through hole and corresponding to the first through slot;
an infrared light filter covering the second through hole and corresponding to the first through slot; and
a driver device configured to move the filter bracket from a first position to a second position;
wherein, in the first position the visible light filter is positioned between the lens and the sensor and in the second position the infrared filter is positioned between the lens and the sensor.
